(19) United States
(12) Patent Application Publication
(10) Pub. No.: US 2006/0074176 A1
(43) Pub. Date: Apr. 6, 2006

(54) Pigment concentrates

(76) Inventor: Gerd Hohner, Am Arenberg (DE)

Correspondence Address: CLARIANT CORPORATION;INTELLECTUAL PROPERTY DEPARTMENT, 4000 MONROE ROAD, CHARLOTTE, NC, 28205, US

(21) Appl. No.: 10/515,401

(22) PCT Filed: May 13, 2003
(86) PCT No.: PCT/EP03/04967

§ 371 Date: Aug. 17, 2005

(30) Foreign Application Priority Data
May 25, 2002 (DE) 102-23-402.7

(51) Int. Cl. C08K 5/00

(52) U.S. Cl. 524/515

(57) ABSTRACT

The invention relates to pigment concentrates for colouring thermoplastic synthetic materials. The invention is characterised in that said pigment concentrates contain copolymers made of a) units which are derived from ?-olefins of the chain length C₁₂-C₆₀, and alternatively b) units which are derived from a carboxylic acid of formula CH₂═CR¹—COOH, and/or units which are derived from a carboxylic acid ester of formula CH₂═CR¹—COOR², and/or d) units which are derived from styrene, 3-methylstyrene, 4-methylstyrene or ?-methylstyrene, wherein R¹ represents a hydrogen atom or a methyl group and R² represents a straight-chained or branched alkyl radical having 1-6 C-atoms.

The present invention relates to pigment concentrates for the coloring of thermoplastics, and also to polyolefin molding compositions or finished polyolefin products colored with the abovementioned pigment concentrates.

The use of pigment concentrates for the coloring of thermoplastics is prior art. These concentrates comprise, alongside the pigment, polar or nonpolar polymer components as carrier material or aid to dispersion. The premixing of the pigment with the polymeric carrier is intended to permit efficient digestion of the pigment agglomerates and effective dispersion of the colorant particles. The objective is that the dispersion of the colorant particles during the incorporation of the concentrate into the plastic is more homogeneous, with finer particles, than would be possible during direct mixing of the pure pigment into the plastic.

Because the quality of dispersion of the pigment is a decisive factor in the color strength achieved in the plastic, substantial industrial and economic importance is attached to the type of concentrate used. The filter pressure generated during the filtration of the pigment-containing melt can be used together with calorimetric test data as a measure of the quality of the dispersion.

Examples of aids to dispersion used in pigment concentrates are low-molecular-weight, noncrystalline or semicrystalline, polar or nonpolar homo- or copolymers, inter alia polyolefin waxes.

DE 42 36 337 A1 describes the use of polymers composed of C₁₂-C₂₂-alkyl acrylates in the form of compositions aiding dispersion for solids in organic media.

DE 195 16 387 A1 claims dispersant compositions for pigment concentrates, composed of a substantially amorphous poly-α-olefin, a polyolefin wax, a crystalline polyolefin, and a polyacrylate.

DE 4139 601 A1 discloses copolymers composed of relatively long-chain α-olefins and of acrylic acids or their esters, and also, where appropriate, of styrene derivatives. These copolymers are suitable release agents and lubricants in the processing of plastics (DE 41 39 601 A1, DE 43 41 395 A1), and are suitable release agents for thermally transferable inscription systems (DE 43 38 879 A1) and are also suitable for the preparation of aqueous dispersions (EP 0 610 844 A1). No use in pigment concentrates is known hitherto.

Surprisingly, it has now been found that copolymers as described in DE 41 39 601 A1 have excellent suitability as an aid to dispersion for the preparation of pigment concentrates. The properties of the copolymners which may be used according to the invention are superior in terms of their dispersing action to those of the polyolefin waxes used hitherto for this purpose, in particular to those of homo- or copolymers of ethylene or of propylene, and to those of copolymers of ethylene with polar comonomers, e.g. acrylic acid or vinyl acetate. The copolymers used according to the invention moreover have the advantage, when compared with the known polar waxes, of being more easily available and less costly.

Conventional polar polyolefin waxes are produced by complicated processes via copolymerization of gaseous olefins, generally ethylene, with polar comonomers at high pressures and high temperatures (cf., by way of example, Ullmann's Encyclopedia of Industrial Chemistry, 5th ed. 1996, Vol. A 28, pages 146-151). In contrast, the copolymers which can be used according to the invention are obtained in a simple manner via reaction of the starting monomers at atmospheric pressure and at comparatively low temperatures.

The invention therefore provides pigment concentrates for the coloring of thermoplastics, where these comprise copolymers, where these are composed of
a) units derived from α-olefins of chain length C₁₂-C₆₀, and optionally
b) units derived from a carboxylic acid of the formula CH₂═CR¹—COOH, and/or
c) units derived from a carboxylic ester of the formula CH₂═CR¹—COOR², and/or
d) units derived from styrene, 3-methylstyrene, 4-methylstyrene, or α-methylstyrene, where R¹ is a hydrogen atom or a methyl group and R² is a straight-chain or branched alkyl radical having from 1 to 6 carbon atoms.

Preference is given to pigment concentrates for the coloring of thermoplastics, where these comprise copolymers, where these are composed of
a) from 20 to 99.5% by weight of units derived from α-olefins of chain length C₁₂-C₆₀.
b) from 0 to 50% by weight of units derived from a carboxy acid of the formula CH₂═CR¹—COOH,
c) from 0 to 60% by weight of units derived from a carboxylic ester of the formula CH₂═CR¹—COOR²,
d) from 0 to 30% by weight of units derived from styrene, 3methylstyrene, 4-methylstyrene, or α-methylstyrene,
   where R¹ is a hydrogen atom or a methyl group and R² is a straight-chain or branched alkyl radical having from 1 to 6 carbon atoms.

Preference is also given to pigment concentrates which comprise copolymers composed of a) and at least of one of the groups b), c), and/or d).

Preference is given to pigment concentrates which comprise the copolymers composed of a) and b).

Preference is given to pigment concentrates which comprise copolymers composed of a) and c).

Preference is given to pigment concentrates which comprise copolymers composed of a) and d).

Preference is likewise given to pigment concentrates which comprise copolymers composed of a), b), and c).

Preference is also given to pigment concentrates which comprise copolymers, where these are composed of
a) from 40to 99% by weight of units derived from α-olefins of chain length C₁₂-C₆₀, and selectively b) and/or c) and/or d), wherein
b) from 0.5 to 40% by weight of units derived from a carboxylic acid of the formula CH₂═CR¹—COOR²,
c) from 0.5 to 40% by weight of units derived from a carboxylic ester of the formula CH₂═CR¹—COOR²,
d) from 0.5 to 30% by weight of units derived from styrene, 3-methylstyrene, 4-methylstyrene, or α-methylstyrene.

The α-olefins preferably lie within the chain length range C₁₈-C₆₀.

The α-olefins particularly preferably lie within the chain length range C₂₆-C₆₀.

The pigment concentrates preferably comprise from 1 to 60% by weight of copolymer, from 10 to 70% by weight of pigment, and from 0 to 70% by weight of polyolefin.

The pigment concentrates preferably comprise from 5 to, 40% by weight of copolymer, from 20 to 50% by weight of pigment and from 10 to 50% by weight of polyolefin.

The polyolefin is preferably a thermoplastic polyolefin.

The invention also provides a polyolefin molding composition or a finished polyolefin product colored with the inventive pigment concentrate.

α-olefins which may be used are those whose chain length is from 12 to 60, preferably from 18 to 60, particularly preferably from 26 to 60, carbon atoms. Use may be made of either olefins having identical chains or else olefin mixtures, e.g. those produced in the known production processes in the form of distillation cuts or distillation residues. Industrial α-olefin mixtures, in particular those having relatively high chain length, may comprise not only 1-alkenes but also relatively high amounts of olefinic double bonds within the chain and pendant to the chain (vinylene groups and vinylidene groups), and also fractions of saturated non-olefinic hydrocarbons.

Unsaturated carboxylic acids used according to the invention are compounds of the general formula CH₂═CR¹—COOH, where R¹ is a hydrogen atom or a methyl group, i.e. acrylic acid or methacrylic acid. Unsaturated carboxylic esters used comprise compounds of the general formula CH₂═CR¹—COOR², where R¹ is as defined above and R² is a straight-chain or branched alkyl radical having from 1 to 6 carborn atoms. Preference is given to the methyl and ethyl esters of acrylic and of methacrylic acid, and particular preference is given to the methyl ester of acrylic acid.

Vinyl aromatic monomers which may be used are styrene, 3-methylstyrene, 4methylstyrene, or α-methylstyrene. It is also possible to use two or more of the carboxylic acids, carboxylic esters, and, where appropriate, styrenes mentioned.

The copolymers are prepared in a manner known per se via copolymerization of the monomers in the presence of free-radical initiators. Appropriate procedures are given by way of example in DE 41 39 601 A1.

Suitable pigments for preparing the pigment concentrate are any of those used for the coloring of plastics. Examples are found in relevant standard works, e.g. Herbst, Hunger, Industrielle organische Pigmenite [Industrial organic pigments], 2nd edn. 1995, pages 4-11. Use may be made of either inorganic or organic pigments. By way of example of inorganic pigments mention may be made of carbon black, titanium dioxide, zinc oxide, and iron oxides. Examples of organic pigments are azo pigments, quinacridone pigments, and phthalocyanine pigments.

For further optimization with respect to industrial use, the concentrate may comprise not only the copolymer used according to the invention and the pigment but also additional components, such as thermoplastics and/or polyolefin waxes or other waxes. Examples of polyolefin waxes which may be used are polyethylene waxes or polypropylene waxes, prepared via free-radical polymerization or via polymerization with the aid of metal-containing coordination catalysts of Ziegler-Natta, Phillips, or metallocene type. Use may also be made of naturally occurring waxes, such as montan wax or carnauba wax, or their downstream products obtainable, by way of example, via oxidation and/or chemical derivatization. These products and production processes are described by way of example in Ullmann's Encyclopedia of Industrial Chemistry, 5th ed. 1996, Vol. A 28, pages 103-160.

In a proven method of preparing the pigment concentrate, the individual solid components are first premixed in suitable mixing assemblies. The from in which copolymer and, where appropriate, waxes are used here may be that of coarse to fine particles, or else a micronized form, for example with median particle sizes (d50 values)≧4 μm. The actual pigment dispersion process then takes place via melting and kneading of the premix in a kneader or extruder.

### EXAMPLES

Acid numbers and saponification numbers, and drop points, were determined to the DIN standards 53402, 53401, and 51801. The melt viscosities were measured with the aid of a rotary viscometer to the standard M-III 8 of the Deutsche Gesellschaft für Fettwissenschaft [German society for the study of fats].

Preparation of the Copolymers

500 g of a commercially available C₂₆-C₆₀-olefin cut (Gulftene 30+, Chevron Phillips Chemical Company) was used as initial charge and heated to 140° C. in a four-necked flask equipped with thermometer, stirrer, dropping funnel, and reflux condenser. At this temperature, mixtures composed of methyl acrylate and acrylic acid in the amounts stated in Table 1, and also 5.0 g of di-tert-butyl peroxide were added dropwise, with stirring, within a period of 5 h. Once the feed had ended, the reaction was allowed to continue for a further 30 min. Volatile constituents were then removed by in-vacuo distillation, and the waxy colorless reaction product was poured out into a dish.

TABLE 1
Inventive α-olefin copolymers

| | Methyl acrylate | Acrylic acid | Acid number | Saponification number | | Visc. at 90° C. |
|---|---|---|---|---|---|---|
| | % by weight¹⁾ | % by weight¹⁾ | mg KOH/g | mg KOH/g | Drop pt. ° C. | mPa · s |
| Copolymer A | 30 | 1.0 | 7 | 196 | 71 | 620 |
| Copolymer B | 20 | 5.0 | 38 | 160 | 72 | 510 |

¹⁾based on the entirety of the monomer components

The copolymers listed in Table 1 were ground (<2 mm) and mixed in a Henschel mixer with the pigment, and also with polypropylene (room temperature, 600 rpm, 10 min). The mixture was then processed in a twin-screw extruder (Berstorff ZE 25×40 D) to give pellets.

Dispersion quality was determined by means of a pressure filter test, and also colorimetrically by way of the color strength of the resultant extrudate (Tables 3/4).

To carry out the pressure filter test, a polyolefin colored with the pigment concentrate was melted in the extruder, and extruded by way of a gear pump through a filter screen (mesh width 25 μm), and the pressure generated upstream of the filter was measured. The poorer the dispersion of the pigment, the higher the pressure generated upstream of the filter. The “filter value” F from the following relationship serves as a measure of the filter pressure, measured in bar:
F=(Pₘₐₓ−Pₒ)/m_{w},
where Pₘₐₓ is the maximum pressure measured upstream of the filter, Pₒ is the pressure upstream of the filter for the uncolored polyolefin, and m_{w} is the weight of throughput of the dispersant composition.

Color strength is determined to DIN 55986.

The following high-pressure polyethylene waxes were used for the comparative examples (Table 2):

| | | Comonomer | | Visc. at |
|---|---|---|---|---|
| | | content in | Drop | 140° C. |
| | Composition | % by weight | pt. ° C. | mPa · s |
| Copolymer C | Ethylene vinyl | about 10 | 93 | 1300 |
| (comparison) | acetate copolymer | | | |
| Copolymer D | Ethylene-acrylic | about 5 | 104 | 1200 |
| (comparison) | acid copolymer | | | |

TABLE 3
Test results and dispersion quality

Pigment: Pigment Red 101 (azo pigment)
Polyolefin: KU 245 (PP homopolymer, MFR_{2.16/230} 30 g/10 min,
producer Borealis)
Ratio by weight pigment:dispersant composition:polyolefin 4:3:3

| | | | Comparative | Comparative |
|---|---|---|---|---|
| | Example 1 | Example 2 | example 1 | example 2 |
| Copolymer or | A | B | C | D |
| comparative | | | | |
| product | | | | |
| Filter value | 3 | 3.5 | 7.5 | 8.3 |
| Relative color | 105 | 106 | 102 | 101 |
| strength¹⁾ | | | | |

¹⁾Color strength of pigment/polyolefin mixture with no addition of dispersant compositions = 100%

TABLE 4
Test results and dispersion quality

Pigment: Pigment Blue 15:3 (phthalocyanine)
Polyolefin: Escorene LL 6101 (LLDPE, MFR_{190/2.16} 20 g/10 min,
producer Exxon)
Ratio by weight pigment:dispersant composition:polyolefin 4:3:3

| | | | Comparative | Comparative |
|---|---|---|---|---|
| | Example 3 | Example 4 | example 3 | example 4 |
| Dispersant | Copolymer | Copolymer | Copolymer | Copolymer |
| composition | A | B | C | D |
| Filter value | 7.5 | 6.8 | 12 | 13 |
| Relative color | 119 | 121 | 110 | 108 |
| strength¹⁾ | | | | |

¹⁾Color strength of pigment/polyolefin mixture with no addition of dispersant compositions = 100%

1. A method for coloring a thermoplastic comprising the step of adding a pigment concentrate to the thermoplastic during processing, wherein the pigment concentrate comprises from 1 to 60% by weight of copolymers, where the copolymers are composed of
a) units derived from α-olefins of chain length C₁₂-C₆₀, and optionally
b) units derived from a carboxylic acid of the formula CH₂═CR¹—COOH, and/or
c) units derived from a carboxylic ester of the formula CH₂═CR¹—COOR², and/or
d) units derived from styrene, 3-methylstyrene, 4-methylstyrene, or α-methylstyrene,
where R¹ is a hydrogen atom or a methyl group and R² is a straight-chain or branched alkyl radical having from 1 to 6 carbon atoms, and from 10 to 70% by weight of a pigment, and from 0 to 70% by weight of a polyolefin.

2. A method for coloring a thermoplastic comprising the step of adding a pigment concentrate to the thermoplastic during processing, wherein the pigment concentrate comprises copolymers composed of
a) from 20 to 99.5% by weight of units derived from α-olefins of chain length C₁₂-C₆₀.
b) from 0 to 50% by weight of units derived from a carboxylic acid of the formula CH₂═CR¹—COOH,
c) from 0 to 60% by weight of units derived from a carboxylic ester of the formula CH₂═CR¹—COOR²,
d) from 0 to 30% by weight of units derived from styrene, 3-methylstyrene, 4-methylstyrene, or α-methylstyrene,
where R¹ is a hydrogen atom or a methyl group and R² is a straight-chain or branched alkyl radical having from 1 to 6 carbon atoms.

3. The method as claimed in claim 1, wherein the pigment concentrate comprises copolymers composed of a) and at least of one of the groups b), c), and/or d).

4. The method as claimed in claim 1, wherein the pigment concentrate comprises copolymers composed of a) and b).

5. The method as claimed in claim 1, wherein the pigment concentrate comprises copolymers composed of a) and c).

6. The method as claimed in claim 1, wherein the pigment concentrate comprises copolymers composed of a) and d).

7. The method as claimed in claim 1, wherein the pigment concentrate comprises copolymers composed of a), b), and c).

8. The method as claimed in claim 1, wherein the pigment concentrate comprises copolymers composed of
a) from 40 to 99% by weight of units derived from α-olefins of chain length C₁₂-C₆₀, and b) and/or c) and/or d), wherein
b) from 0.5 to 40% by weight of units derived from a carboxylic acid of the formula CH₂═CR¹—COOH,
c) from 0.5 to 40% by weight of units derived from a carboxylic ester of the formula CH₂═CR¹—COOR²,
d) from 0.5 to 30% by weight of units derived from styrene, 3-methylstyrene, 4-methylstyrene, or α-methylstyrene.

9. The method as claimed in claim 1, wherein the α-olefins have a chain length range of C₁₈-C₆₀.

10. The method as claimed in claim 1, wherein the α-olefins lie have a chain length range of C₂₆-C₆₀.

11. The method as claimed in claim 1, wherein the pigment concentrate comprises from 5 to 40% by weight of copolymer, from 20 to 50% by weight of pigment, and from 10 to 50% by weight of polyolefin.

12. The method as claimed in claim 1, wherein the polyolefin is a thermoplastic polyolefin.

13. A thermoplastic colored in accordance with the method of claim 1.

14. A thermoplastic colored in accordance with the method of claim 2.

15. A thermoplastic colored in accordance with the method of claim 3.
